(19) United States
(12) Patent Application Publication
(10) Pub. No.: US 2025/0385813 A1
(43) Pub. Date: Dec. 18, 2025

(54) SYSTEM AND METHOD FOR PUSCH SYMBOL RATE PROCESSING

(71) Applicant: JIO PLATFORMS LIMITED, Ahmedabad, Gujarat (IN)

(72) Inventors: Vinod Kumar SINGH, Navi Mumbai, Maharashtra (IN); Yashesh BUCH, Navi Mumbai, Maharashtra (IN); Santhi Swaroop CHINNAM; Gayathri R NAIR; Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/880,006

(22) PCT Filed: Aug. 30, 2023
(86) PCT No.: PCT/IB2023/058566

§ 371 Date: Dec. 30, 2024

(30) Foreign Application Priority Data
Aug. 31, 2022 (IN) 202221049805

(51) Int. Cl. H04L 25/02; H04L 25/03

(52) U.S. Cl. CPC H04L 25/0204; H04L 25/0256; H04L 25/03006

(57) ABSTRACT

The present disclosure provides a system and a method for physical uplink shared channel (PUSCH) symbol rate processing. The system receives one or more signals from various users via a physical uplink shared channel (PUSCH). Further, the system bifurcates the input into two halves namely a symbol rate processing (SRP) stage and a bit rate processing (BRP) stage. The SRP stage stores one or more orthogonal frequency division multiplexing (OFDM) symbols associated with the signals. Further, the SRP stage processes the signal using an equalizer and stores an equalized output in an equalizer buffer. The equalizer uses two separate streams for processing even and odd samples and helps in completing the SRP stage quickly by reducing the processing time by fifty percent. The BRP stage receives an output from the equalizer buffer and decodes the output based on a user requirement.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for processing various signals in a wireless telecommunications system. More particularly, the present disclosure relates to a system and a method for physical uplink shared channel (PUSCH) symbol rate processing.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

A physical uplink shared channel (PUSCH) in a fifth generation (5G) new radio (NR) carries multiple user equipments' (UEs) uplink data multiplexed over time and frequency resources. On any given slot, to decode all the scheduled UEs' data, a PUSCH receiver takes bare minimum of two slots time, one to receive a complete slot data and another slot for processing the slot data. This two slot-processing time forces the PUSCH receiver design to incorporate buffering of received data in order to avoid any data being overwritten by a next slot's data prior to a decoding process. A typical PUSCH receiver design maintains a slot buffer immediately after the data is converted to a frequency grid. Further, the PUSCH receiver using two slots of processing time requires a buffer which may store up to two slots of frequency grid data. By considering 5G bandwidths and the number of receiving antennae, this buffer ends up consuming a lot of random access memory (RAM) in a field programmable gate array (FPGA). Alternate method suggests storing the frequency grid data in a double data RAM (DDR). However, cost associated with the DDR design complexity and resource utilization associated with a DDR controller may be high.

Conventional methods use a buffer in the DDR or store the data in the RAM in a ping-pong manner. A method of buffering in the DDR is associated with a complexity of a DDR controller, which makes it a poor choice for the PUSCH receiver design. Moreover, the resource utilization of the DDR controller itself comes around 10,000 lookup tables (LUTs) and flip flops (FFs), which makes it even less desirable for a resource constrained FPGA platform. A method of storing data in the RAM makes the memory access simple unlike DDR access but involves a high cost of FPGA utilization. Storing this much of data by using block RAMs (BRAMs) leads to the BRAM congestion on FPGA board and may fail to meet a timing requirement. For a specific configuration of 100 Megahertz with a sub carrier spacing of 30 Kilohertz and 4 receiving antennae, this method requires 1.4 Megabytes which is equivalent to 320 BRAMs each of size 36 Kb in the FPGA.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method where a simple receiver design is used with lesser number of field programmable gate array (FPGA) resources.

It is an object of the present disclosure to provide a system and a method where a physical uplink shared channel (PUSCH) receiver chain is divided into a symbol rate processing (SRP) stage and a bit rate processing (BRP) stage.

It is an object of the present disclosure to provide a system and a method that uses a symbol separator buffer at a frequency grid level which stores only one slot of received data and an equalizer buffer which stores one slot of equalized output.

It is an object of the present disclosure to provide a system and a method where the SRP stage processes the received data taken from the symbol separator buffer and stores the equalized output in the equalizer buffer.

It is an object of the present disclosure to provide a system and a method where the BRP takes data from the equalizer buffer and processes the data using a cyclic redundancy check (CRC) decoding technique based on user requirements.

It is an object of the present disclosure to provide a system and a method that ensures that the symbol separator buffer is not being overwritten before completing the decoding process associated with the SRP processing.

It is an object of the present disclosure to provide a system and a method that uses two separate streams for processing even and odd samples at an equalizer and aids in completing the SRP processing quickly.

It is an object of the present disclosure to provide a system and a method that uses a buffer at the equalizer output to ensure that no data is lost during the SRP processing.

It is an object of the present disclosure to provide a system and a method where a demodulation reference signal (DMRS) is efficiently processed.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for processing signals during an uplink transmission. The system includes a processor and a memory operatively coupled to the processor, where the memory stores instructions to be executed by the processor. The processor receives one or more signals from a computing device associated with one or more users. The one or more signals are based on one or more subcarriers received in a physical uplink shared channel (PUSCH). The processor determines one or more orthogonal frequency division multiplexing (OFDM) symbols within a physical resource block (PRB) based on the one or more subcarriers. The processor stores the one or more OFDM symbols in a symbol separation buffer. The processor generates a demodulation reference signal (DMRS) sequence associated with the one or more OFDM symbols from the symbol separation buffer. The processor generates one or more channel estimates associated with the DMRS sequence. The processor generates one or more frequency interpolated channel estimates based on the one or more channel estimates and bifurcates the one or more frequency interpolated channel estimates into time interpolated channel estimates. The processor generates equalized data based on the time interpolated channel estimates and the one or more OFDM symbols. The processor stores the equalized data in an equalizer buffer. The processor utilizes the equalized data from the equalizer buffer for bit rate processing (BRP) based on a requirement from the one or more users.

In an embodiment, the processor may determine the one or more channel estimates using a least square estimation technique.

In an embodiment, the processor may generate the one or more frequency interpolated channel estimates using an averaging technique.

In an embodiment, the processor may de-noise the one or more frequency interpolated channel estimates using a frequency domain filtering technique prior to the generation of the time interpolated channel estimates.

In an embodiment, the processor may extrapolate the one or more frequency interpolated channel estimates using a first order linear interpolation technique prior to the generation of the equalized data.

In an embodiment, the processor may generate the equalized data using a minimum mean square estimation (MMSE) technique.

In an embodiment, the processor may bifurcate the one or more frequency interpolated channel estimates into the time interpolated channel estimates including an even sample and an odd sample prior to the generation of the equalized data. In an embodiment, the equalized data may include even equalized data and odd equalized data corresponding to the respective even sample and odd sample.

In an embodiment, the processor may generate the DMRS sequence using a linear feedback shift register (LFSR).

In an embodiment, the LFSR may include at least one of a slot number, a symbol number, a scrambling identification (ID), and the PRB.

In an aspect, the present disclosure relates to a method for processing signals during an uplink transmission. The method includes receiving, by a processor associated with a system, one or more signals from a computing device associated with one or more users. The one or more signals are based on one or more subcarriers received in a PUSCH. The method includes determining, by the processor, one or more OFDM symbols within a PRB based on the one or more subcarriers. The method includes storing, by the processor, the one or more OFDM symbols in a symbol separation buffer. The method includes generating, by the processor, a DMRS sequence associated with the one or more OFDM symbols from the symbol separation buffer. The method includes generating, by the processor, one or more channel estimates associated with the DMRS sequence. The method includes generating, by the processor, one or more frequency interpolated channel estimates based on the one or more channel estimates and bifurcating the one or more frequency interpolated channel estimates into time interpolated channel estimates. The method includes generating, by the processor, equalized data based on the time interpolated channel estimates and the one or more OFDM symbols. The method includes storing, by the processor, the equalized data in an equalizer buffer. The method includes utilizing, by the processor, the equalized data from the equalizer buffer for BRP based on a requirement from the one or more users.

In an embodiment, the method may include determining, by the processor, the one or more channel estimates using a least square estimation technique.

In an embodiment, the method may include generating, by the processor, the one or more frequency interpolated channel estimates using an averaging technique.

In an embodiment, the method may include de-noising, by the processor, the one or more frequency interpolated channel estimates using a frequency domain filtering technique prior to the generation of the time interpolated channel estimates.

In an embodiment, the method may include extrapolating, by the processor, the one or more frequency interpolated channel estimates using a first order linear interpolation technique prior to the generation of the equalized data.

In an embodiment, the method may include generating, by the processor, the equalized data using a MMSE technique.

In an embodiment, the method may include bifurcating, by the processor, the one or more frequency interpolated channel estimates into the time interpolated channel estimates including an even sample and an odd sample prior to the generation of the equalized data. In an embodiment, the equalized data may include even equalized data and odd equalized data corresponding to the respective even sample and odd sample.

In an embodiment, the method may include generating, by the processor, the DMRS sequence using a LFSR.

In an aspect, a non-transitory computer readable medium includes a processor with executable instructions that cause the processor to receive one or more signals from a computing device associated with one or more users. The one or more signals are based on one or more subcarriers received in a PUSCH. The one or more signals are based on one or more subcarriers received in the PUSCH. The processor determines one or more OFDM symbols within a PRB based on the one or more subcarriers. The processor stores the one or more OFDM symbols in a symbol separation buffer. The processor generates a DMRS sequence associated with the one or more OFDM symbols from the symbol separation buffer.

The processor generates one or more channel estimates associated with the DMRS sequence. The processor generates one or more frequency interpolated channel estimates based on the one or more channel estimates and bifurcates the one or more frequency interpolated channel estimates into time interpolated channel estimates. The processor generates equalized data based on the time interpolated channel estimates and the one or more OFDM symbols. The processor stores the equalized data in an equalizer buffer. The processor utilizes the equalized data from the equalizer buffer for BRP chain based on a requirement from the one or more users.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example processing timing diagram (300) of a physical uplink channel (PUSCH) receiver, in accordance with an embodiment of the present disclosure.

FIG. 4 illustrates an example flow diagram (400) for PUSCH symbol rate processing, in accordance with an embodiment of the present disclosure.

FIG. 5 illustrates an example computer system (500) in which or with which embodiments of the present disclosure may be implemented.

The foregoing shall be more apparent from the following more detailed description of the disclosure.

### DEATILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In accordance with embodiments of the present disclosure, a physical uplink shared channel (PUCSH) receiver chain is divided into two halves namely a symbol rate processing (SRP) stage and a bit rate processing (BRP) stage. The system/PUSCH receiver (108) may use a buffer such as but not limited to a symbol separator buffer at a frequency grid level that may store only one slot of received data and a buffer named equalizer buffer that may store one slot of equalized output. The SRP stage may process the received data from the symbol separator buffer and store the equalized output in the equalizer buffer. The BRP stage may receive the data from the equalizer buffer and process the data using a cyclic redundancy check (CRC) decoding technique. Also, the system (108) may ensure that the symbol separator buffer is not overwritten before decoding the symbol separator buffer by completing the SRP processing quickly.

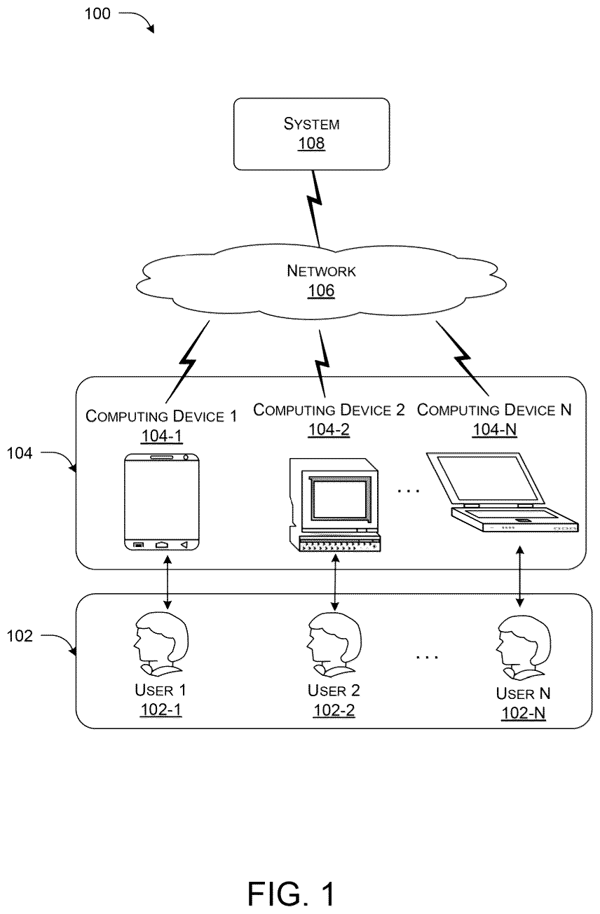

The various embodiments throughout the disclosure will be explained in more detail with reference to FIGS. 1-5.

FIG. 1 illustrates an example network architecture (100) for implementing a proposed system (108), in accordance with an embodiment of the present disclosure.

As illustrated in FIG. 1, the network architecture (100) may include a system (108). The system (108) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). In an embodiment, the system (108) may be interchangeably referred as a physical uplink shared channel (PUSCH) receiver of a base station.

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may use only 199 block random access memories (BRAMs) each of size 36 Kb in a field programmable gate array (FPGA) based on a two-stage buffering mechanism. Further, the system (108) may utilize the SRP stage and the BRP stage split mechanism to ensure that the SRP processing is performed quickly before the next slot data arrives by processing two samples simultaneously at a time during an equalization stage.

In an embodiment, system (108) may receive one or more signals from the computing device (104) associated with the users (102). The one or more signals may be based on one or more subcarriers received in a PUSCH. The one or more signals may be a pulse amplitude modulated signal may include a linear feedback shift register (LFSR). Further, the LFSR may include, but not limited to, a slot number, a symbol number, a scrambling identifier (ID), and the physical resource block (PRB). Further, the one or more signals may be based on one or more subcarriers received in the PUSCH.

In an embodiment, the system (108) may determine one or more orthogonal frequency division multiplexing (OFDM) symbols within a PRB based on the one or more subcarriers and store the one or more OFDM symbols in a symbol separation buffer.

In an embodiment, the system (108) may generate a demodulation reference

signal (DMRS) sequence associated with the one or more OFDM symbols from the symbol separation buffer. The system (108) may generate the DMRS sequence using the LFSR.

In an embodiment, the system (108) may generate one or more channel estimates associated with the DMRS sequence. Further, the system (108) may generate the one or more channel estimates using a least square estimation technique.

In an embodiment, the system (108) may generate one or more frequency interpolated channel estimates based on the one or more channel estimates and bifurcate the one or more frequency interpolated channel estimates into time interpolated channel estimates. The system (108) may generate the one or more frequency interpolated channel estimates using an averaging technique.

Further, in an embodiment, the system (108) may de-noise the one or more frequency interpolated channel estimates using a frequency domain filtering technique prior to generation of the time interpolated channel estimates. The system (108) may extrapolate the one or more frequency interpolated channel estimates using a first order linear interpolation technique prior to generation of the equalized data.

In an embodiment, the system (108) may bifurcate the one or more frequency interpolated channel estimates into time interpolated channel estimates including an even sample and an odd sample. The system (108) may extrapolate the bifurcated one or more frequency interpolated channel estimates using a first order linear interpolation technique.

In an embodiment, the system (108) may bifurcate the one or more frequency interpolated channel estimates by extrapolating the one or more frequency interpolated channel estimates separately into an even sample and an odd sample prior to the generation of the equalized data.

In an embodiment, the system (108) may generate the equalized data based on the time interpolated channel estimates and the one or more OFDM symbols. The system (108) may generate the equalized data using a minimum mean square estimation (MMSE) technique. The equalized data may include even equalized data and odd equalized data corresponding to the respective even sample and odd sample. The system (108) may store the equalized data associated with the one or more subcarriers in an equalizer buffer. Further, the system (108) may utilize the equalized data from the equalizer buffer for bit rate processing (BRP) based on a requirement from the one or more users (102).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

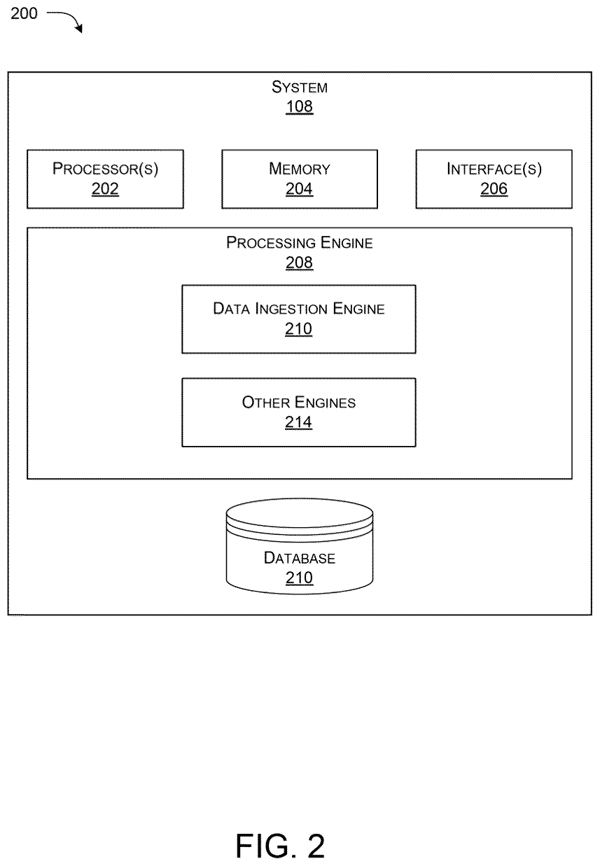

FIG. 2 illustrates an exemplary block diagram (200) of a proposed system

(108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212) and other engine(s) (214). In an embodiment, other engine(s) (214) may include, but not limited to, a parameter engine, an input/output engine, and a notification engine.

In an embodiment, the processor (202) may receive one or more signals via the data ingestion engine (212). The one or more signals may be received from a computing device (104) associated with one or more users (102). The processor (202) may store the one or more signals in the database (210). The one or more signals may be based on one or more subcarriers received in a PUSCH. The one or more signals may be a pulse amplitude modulated signal that may include a LFSR. Further, the LFSR may include, but not limited to, a slot number, a symbol number, a scrambling ID, and the PRB.

In an embodiment, the processor (202) may determine OFDM symbols within a PRB based on the one or more subcarriers and store the one or more OFDM symbols in a symbol separation buffer.

In an embodiment, the processor (202) may generate a DMRS sequence associated with the one or more OFDM symbols from the symbol separation buffer. The processor (202) may generate the DMRS sequence using the LFSR.

In an embodiment, the processor (202) may generate one or more channel estimates associated with the DMRS sequence. Further, the processor (202) may generate the one or more channel estimates using a least square estimation technique.

In an embodiment, the processor (202) may generate one or more frequency interpolated channel estimates based on the one or more channel estimates and bifurcate the one or more frequency interpolated channel estimates into time interpolated channel estimates. The processor (202) may generate the one or more frequency interpolated channel estimates using an averaging technique.

Further, in an embodiment, the processor (202) may de-noise the one or more frequency interpolated channel estimates using a frequency domain filtering technique prior to generation of the time interpolated channel estimates. The processor (202) may extrapolate the one or more frequency interpolated channel estimates using a first order linear interpolation technique prior to generation of the equalized data.

In an embodiment, the processor (202) may bifurcate the one or more frequency interpolated channel estimates into the time interpolated channel estimates including an even sample and an odd sample. The processor (202) may extrapolate the bifurcated one or more frequency interpolated channel estimates using a first order linear interpolation technique.

In an embodiment, the processor (202) may bifurcate the one or more frequency interpolated channel estimates by extrapolating the one or more frequency interpolated channel estimates separately into an even sample and an odd sample prior to the generation of the equalized data.

In an embodiment, the processor (202) may generate the equalized data based on the time interpolated channel estimates and the one or more OFDM symbols. The system (108) may generate the equalized data using a MMSE technique. The processor (202) may store the equalized data associated with the one or more subcarriers in an equalizer buffer. In some embodiments, the equalized data may include even equalized data and odd equalized data corresponding to the even sample and the odd sample, respectively. Further, the processor (202) may utilize the equalized data from the equalizer buffer for BRP based on a requirement from the one or more users (102).

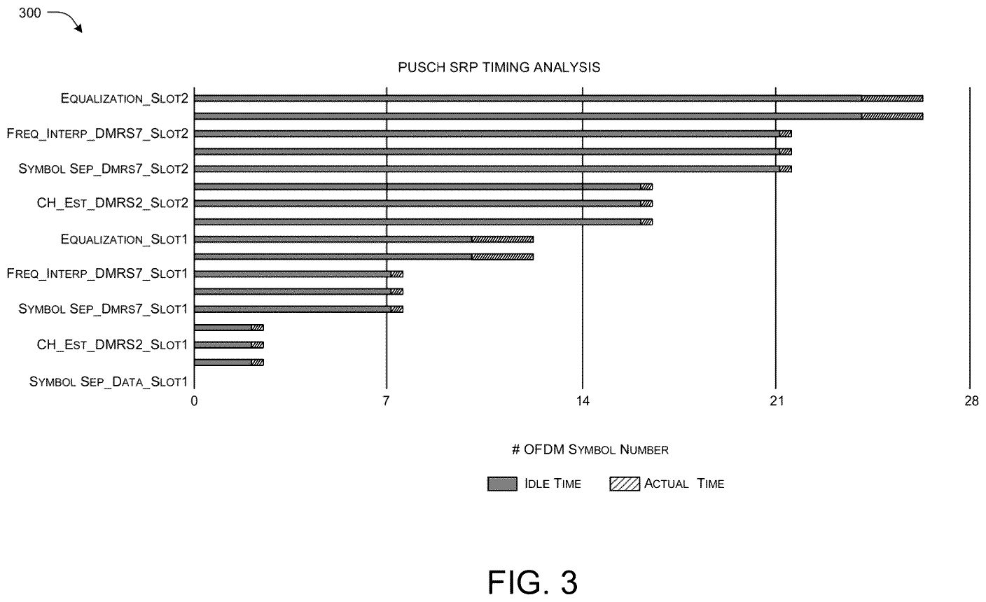

FIG. 3 illustrates an example processing timing diagram (300) of the PUSCH receiver, in accordance with an embodiment of the present disclosure.

As illustrated in FIG. 3, in an embodiment, the system (108) may implement two separate streams, namely the SRP stage and the BRP stage for processing even and odd samples at the equalizer stage and aid in completing the SRP processing quickly.

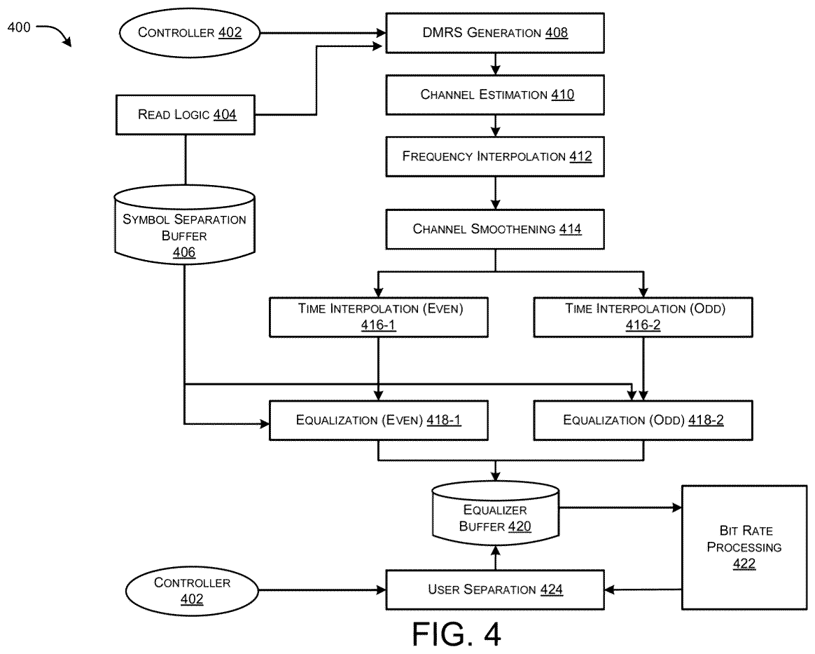

In an embodiment, a PUSCH receiver or the system (108) with a processing delay of two slots may take 320 BRAMs each of size 36 Kb using a double data random access memory (DDR) buffering method, whereas the system (108) may take only 199 BRAMs each of size 36 Kb with the present method. Similarly, for a delay of three slots time, the system (108) may take 239 BRAMs each of size 36 Kb with the present method, whereas the DDR buffering method may take 477 BRAMs each of size 36 Kb. Further, the DDR buffering method for a specific configuration of 100 Megahertz with a sub carrier spacing of 30 Kilohertz and 4 receiving antennae, may require 1.4 Megabytes which may be equivalent to 320 BRAMs each of size 36 Kb in FPGA. The present method will be explained with reference to FIG. 4 below.

FIG. 4 illustrates an example flow diagram (400) for PUSCH symbol rate processing, in accordance with an embodiment of the present disclosure.

As illustrated in FIG. 4, a controller (402) associated with the system (108) may receive one or more signals including one or more subcarriers on the PUSCH from the one or more users (102). Further, the one or more subcarriers may include the one or more OFDM symbols.

In an embodiment, the user data from one slot may be stored in a symbol separation buffer (406). The symbol separation buffer (406) may distinguish between a data symbol and a DMRS symbol in the given slot. A read logic module (404) may be a control circuit which generates a read address towards the symbol separation buffer (406) where the user data may be stored. The read logic module (406) may read data from the symbol separation buffer (406) and send this information to respective modules for further processing. Upon receiving the first DMRS symbol (3^{rd} OFDM symbol), the read logic module (404) may generate a read address towards the symbol separation buffer (406) in order to receive information from the user data. At the same time, a DMRS generation module (408) may start generating pseudo-noise (PN) sequences for all scheduled UEs (104).

In an embodiment, a DMRS in a fifth generation (5G) new radio (NR) specification may be a PN sequence which may be typically realized by a LFSR. As per the specification, the initial seed value of the LFSR may be a function of slot number, symbol number, scrambling ID, and the allocated start PRB. A typical DMRS design may initialize the LFSR with the calculated seed value, sequencing the LFSR from a zero state till the LFSR reaches a specific defined initial state. From that state onwards, based on the PN sequence from the LFSR, every cycle may include a DMRS sequence. This procedure may cause processing delays because of the cycles required to reach the required initial state. A total processing delay may be proportional to the start PRB of a particular allocated UE (104) and the number of UEs (104) scheduled on a particular slot. To avoid the processing delay, the DMRS generation module (408) may store the states of LFSR for all PRBs. With this approach, deriving a DMRS value for various UEs (104) with a specific start PRB may involve fetching a corresponding state value of the LFSR from the BRAM followed by a bit wise operation of the seed value. Even though this approach may utilize 2 BRAMs each of size 36 Kb for storing the initial state of all PRBs, this approach may help to deliver the DMRS values and aid the SRP stage to finish quickly. This approach may enable a channel estimation stage to start as early as a 4^{th} OFDM symbol onwards.

In an embodiment, a channel estimation module (410) may accept the one or more signals from the symbol separator buffer (406) and the one or more subcarriers from the

DMRS generation module (408) and perform a least square estimation using a least square estimation technique. The estimated values may be sent to a frequency interpolation module (412) which may perform interpolation across the one or more subcarriers using an averaging technique and generate one or more frequency interpolated channel estimates. The one or more frequency interpolated channel estimates may be sent to a channel smoothening module (414). The channel smoothening module (414) may filter the one or more frequency interpolated channel estimates by using a frequency domain filtering technique. Since the slot user data is stored at the input of the PUSCH receiver (108), the user data may be quickly processed before the user data gets replaced by a new slot user data. This urgency may be addressed by splitting the SRP stage prior to a time interpolation stage and the equalization stage. An output form the SRP stage may be bifurcated into two halves in which one stream may process even samples and the other stream may process odd samples associated with the one or more frequency interpolated channel estimates. Hence, processing the even and odd samples at a time may empty the symbol separator buffer (406) quickly, thereby making room for the new slot user data.

In an embodiment, the time interpolation module (416-1, 416-2 or 416) may extrapolate the one or more frequency interpolated channel estimates using the first order linear interpolation technique to generate one or more time interpolated channel estimates. The interpolated samples may be sent to an equalization module (418-1, 418-2 or 418). The equalization module (418) may equalize the received user data from the symbol separator buffer (406) and the one or more time interpolated channel estimates from the time interpolation module (416-1, 416-2). Weights from the equalization stage may be derived using a minimum mean square estimation (MMSE) technique. The equalized data of one slot may be stored in an equalizer buffer (420). Further, a user separation module (424) may separate the equalized data based on the input from the one or more users (102) and sends to the BRP module (422). Further, the BRP module (422) may process the equalized data using the CRC decoding technique.

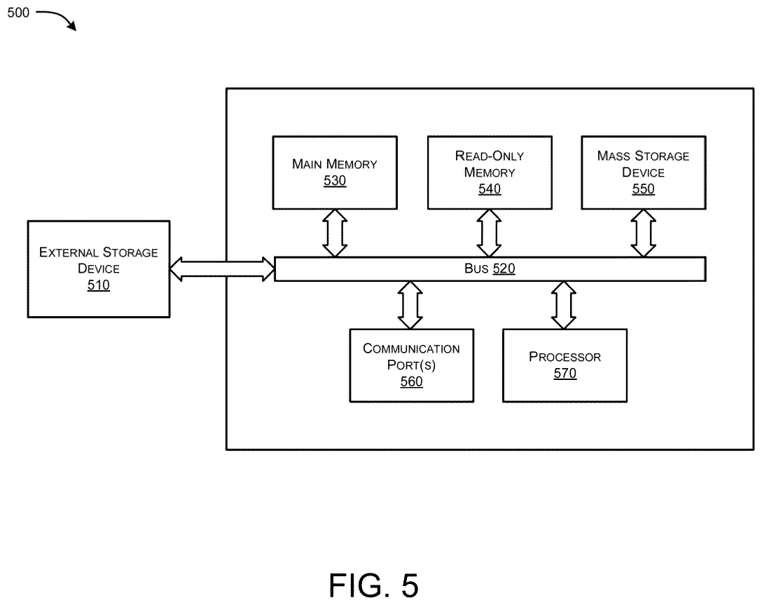

FIG. 5 illustrates an exemplary computer system (500) in which or with which embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method where lesser memory resources are utilized by maintaining two block random access memories (BRAMs) each of size 36 Kb, one at frequency grid level and other after equalization.

The present disclosure provides a system and a method where a physical uplink shared channel (PUSCH) receiver design may be used without dependency of a double data random access memory (DDR) memory and a DDR controller.

The present disclosure provides a system and a method that processes an uplink chain as two halves such as a symbol rate processing (SRP) stage where data is processed in symbol by symbol manner and a bit rate processing (BRP), where data is processed on a user requirement.

The present disclosure provides a system and a method that completes the SRP stage quickly with the help of having odd and even samples processed at a time interpolation and an equalization stage.

The present disclosure provides a system and a method that uses a field programmable gate array (FPGA) platform with an efficient and a low complexity PUSCH receiver design.

I/we claim:

1. A system (108) for processing signals during an uplink transmission, the system (108) comprising:
a processor (202); and
a memory (204) operatively coupled with the processor (202), wherein said memory (204) stores instructions which, when executed by the processor (202), cause the processor (202) to:
receive one or more signals from a computing device (104) associated with one or more users (102), wherein the one or more signals are based on one or more subcarriers received in a physical uplink shared channel (PUSCH);
determine one or more orthogonal frequency division multiplexing (OFDM) symbols within a physical resource block (PRB) based on the one or more subcarriers and store the one or more OFDM symbols in a symbol separation buffer;
generate a demodulation reference signal (DMRS) sequence associated with the one or more OFDM symbols from the symbol separation buffer;
generate one or more channel estimates associated with the DMRS sequence;
generate one or more frequency interpolated channel estimates based on the one or more channel estimates and bifurcate the one or more frequency interpolated channel estimates into time interpolated channel estimates;
generate equalized data based on the time interpolated channel estimates and the one or more OFDM symbols, wherein the equalized data is stored in an equalizer buffer; and
utilize the equalized data from the equalizer buffer for bit rate processing (BRP) based on a requirement from the one or more users (102).

2. The system (108) as claimed in claim 1, wherein the processor (202) is to determine the one or more channel estimates using a least square estimation technique.

3. The system (108) as claimed in claim 1, wherein the processor (202) is to generate the one or more frequency interpolated channel estimates using an averaging technique.

4. The system (108) as claimed in claim 1, wherein the processor (202) is to de-noise the one or more frequency interpolated channel estimates using a frequency domain filtering technique prior to the generation of the time interpolated channel estimates.

5. The system (108) as claimed in claim 1, wherein the processor (202) is to extrapolate the one or more frequency interpolated channel estimates using a first order linear interpolation technique prior to the generation of the equalized data.

6. The system (108) as claimed in claim 1, wherein the processor (202) is to generate the equalized data using a minimum mean square estimation (MMSE) technique.

7. The system (108) as claimed in claim 1, wherein the processor (202) is to bifurcate the one or more frequency interpolated channel estimates into the time interpolated channel estimates comprising an even sample and an odd sample prior to the generation of the equalized data, and wherein the equalized data comprises even equalized data and odd equalized data corresponding to the respective even sample and odd sample.

8. The system (108) as claimed in claim 1, wherein the processor (202) is to generate the DMRS sequence using a linear feedback shift register (LFSR).

9. The system (108) as claimed in claim 8, wherein the LFSR comprises at least one of:
a slot number, a symbol number, a scrambling identifier (ID), and the PRB.

10. A method for processing signals during an uplink transmission, the method comprising:
receiving, by a processor (202) associated with a system (108), one or more signals from a computing device (104) associated with one or more users (102), wherein the one or more signals are based on one or more subcarriers received in a physical uplink shared channel (PUSCH);
determining, by the processor (202), one or more orthogonal frequency division multiplexing (OFDM) symbols within a physical resource block (PRB) based on the one or more subcarriers and storing the OFDM symbols in a symbol separation buffer;
generating, by the processor (202), a demodulation reference signal (DMRS) sequence associated with the one or more OFDM symbols from the symbol separation buffer;
generating, by the processor (202), one or more channel estimates associated with the DMRS sequence;
generating, by the processor (202), one or more frequency interpolated channel estimates based on the one or more channel estimates and bifurcate the one or more frequency interpolated channel estimates into time interpolated channel estimates;
generating, by the processor (202), equalized data based on the time interpolated channel estimates and the one or more OFDM symbols, wherein the equalized data is stored in an equalizer buffer; and
utilizing, by the processor (202), the equalized data from the equalizer buffer for bit rate processing (BRP) based on a requirement from the one or more users (102).

11. The method as claimed in claim 10, comprising determining, by the processor (202), the one or more channel estimates using a least square estimation technique.

12. The method as claimed in claim 10, comprising generating, by the processor (202), the one or more frequency interpolated channel estimates using an averaging technique.

13. The method as claimed in claim 10, comprising de-noising, by the processor (202), the one or more frequency interpolated channel estimates using a frequency domain filtering technique prior to the generation of the time interpolated channel estimates.

14. The method as claimed in claim 10, comprising extrapolating, by the processor (202), the one or more frequency interpolated channel estimates using a first order linear interpolation technique prior to the generation of the equalized data.

15. The method as claimed in claim 10, comprising generating, by the processor (202), the equalized data using a minimum mean square estimation (MMSE) technique.

16. The method as claimed in claim 10, comprising bifurcating, by the processor (202), the one or more frequency interpolated channel estimates into the time interpolated channel estimates comprising an even sample and an odd sample prior to the generation of the equalized data, wherein the equalized data comprises even equalized data and odd equalized data corresponding to the respective even sample and odd sample.

17. The method as claimed in claim 10, comprising generating, by the processor (202), the DMRS sequence using a linear feedback shift register (LFSR).

18. A non-transitory computer readable medium comprising a processor with executable instructions, causing the processor to:
receive one or more signals form a computing device (104) associated with the one or more users (102), wherein the one or more signals are based on one or more subcarriers received in a physical uplink shared channel (PUSCH);
determine one or more orthogonal frequency division multiplexing (OFDM) symbols within a physical resource block (PRB) based on the one or more subcarriers and store the one or more OFDM symbols in a symbol separation buffer;
generate a demodulation reference signal (DMRS) sequence associated with the one or more OFDM symbols from the symbol separation buffer;
generate one or more channel estimates associated with the DMRS sequence;
generate one or more frequency interpolated channel estimates based on the one or more channel estimates and bifurcate the one or more frequency interpolated channel estimates into time interpolated channel estimates;
generate equalized data based on the time interpolated channel estimates and the one or more OFDM symbols, wherein the equalized data is stored in an equalizer buffer; and
utilize the equalized data from the equalized buffer for bit rate processing (BRP) based on a requirement from the one or more users (102).
